(19) United States
(12) Patent Application Publication
(10) Pub. No.: US 2025/0355270 A1
(43) Pub. Date: Nov. 20, 2025

(54) STEREOSCOPIC DISPLAY SUBSTRATE AND DISPLAY APPARATUS

(71) Applicants: Beijing BOE Display Technology Co., Ltd., Beijing (CN); BOE Technology Group Co., Ltd., Beijing (CN); Beijing BOE Technology Development Co., Ltd., Beijing (CN)

(72) Inventors: Yue GUO, Beijing (CN); Weifan YANG, Beijing (CN); Xing ZHOU, Beijing (CN); Hongchuan DU, Beijing (CN); Jianbo WANG, Beijing (CN); Heyang ZHANG, Beijing (CN); Tianhui ZHAO, Beijing (CN); Baoman LI, Beijing (CN)

(21) Appl. No.: 18/996,336

(22) PCT Filed: Mar. 13, 2024
(86) PCT No.: PCT/CN2024/081374

§ 371 Date: Jan. 17, 2025

(30) Foreign Application Priority Data
Apr. 28, 2023 (CN) 202310478445.X

(51) Int. Cl. G02B 30/27; G02B 3/00

(52) U.S. Cl. CPC G02B 30/27; G02B 3/005

(57) ABSTRACT

A display substrate is provided including: a base substrate; a display unit on the base substrate, including pixel units arranged in an array in a first direction and a second direction, where the pixel units have a periodic pixel width Δx in the first direction; a first medium layer on a side of the display unit away from the base substrate; and a cylindrical lens grating unit on a side of the first medium layer away from the base substrate, including a hard substrate and cylindrical lenses contiguously arranged in the first direction, each cylindrical lens having a pitch P. The stereoscopic display substrate has a preset field of view position with an optimal display effect in a third direction; is perpendicular to both the first and second directions. In a direction away from the field of view origin along the first direction, pitches P of the cylindrical lenses increase.

### CROSS-REFERENCE TO RELATED APPLICATION

This application is a Section 371 National Stage Application of International Application No. PCT/CN2024/081374, filed on Mar. 13, 2024, entitled “STEREOSCOPIC DISPLAY SUBSTRATE AND DISPLAY APPARATUS”, and published as WO 2024/222255, published Oct. 31, 2024, not in English, which claims priority to Chinese Patent Application No. 202310478445.X filed on Apr. 28, 2023, the contents of which are incorporated herein by reference in their entireties.

### TECHNICAL FIELD

The present disclosure relates to the field of display technology, and in particular to a stereoscopic display substrate and a display apparatus.

### BACKGROUND

Stereoscopic displays, as an important part of the display field, are a key research direction of various research institutions and display technology companies, and are widely used in medical imaging, education and teaching, virtual reality, etc. Stereoscopic displays have display quality problems such as crosstalk, ghosting, etc., which may greatly limit the large-scale application of the stereoscopic products.

### SUMMARY

Embodiments of the present disclosure provide a stereoscopic display substrate and a display apparatus.

In an aspect, a stereoscopic display substrate is provided, including:
a base substrate;
a display unit disposed on a side of the base substrate, where the display unit includes a plurality of pixel units arranged in an array in a first direction and a second direction, the plurality of pixel units have a periodic pixel width Δx in the first direction, and the first direction intersects with the second direction;
a first medium layer disposed on a side of the display unit away from the base substrate; and
a cylindrical lens grating unit disposed on a side of the first medium layer away from the base substrate, where the cylindrical lens grating unit includes a hard substrate and a plurality of cylindrical lenses contiguously arranged in the first direction, and each of the plurality of cylindrical lenses has a pitch P,
where the stereoscopic display substrate has a preset field of view position with an optimal display effect in a third direction, and the third direction is perpendicular to both the first direction and the second direction;
in a direction away from a field of view origin along the first direction, pitches P of the cylindrical lenses increase, the field of view origin is an intersection of the third direction, the first direction and the second direction, and a spacing between the preset field of view position and the field of view origin in the third direction is E_{z};
the pitch P of each of the plurality of cylindrical lenses is calculated based on a refractive pixel spacing yₖ and at least one of a preset cylindrical lens number m of the plurality of cylindrical lenses and the periodic pixel width Δx, and the refractive pixel spacing yₖ is a spacing between a pixel unit corresponding to a k^{th} cylindrical lens and the field of view origin in a case of taking cylindrical lens refraction into account, k being an integer greater than 0; and
a difference between the refractive pixel spacing yₖ and an original pixel spacing yₒ of the cylindrical lens is less than or equal to a crosstalk limit M, the crosstalk limit is associated with a pitch of the pixel unit in the first direction, and the original pixel spacing yₒ is a spacing between the pixel unit corresponding to the k^{th} cylindrical lens and the field of view origin in a case of not taking the cylindrical lens refraction into account.

In some exemplary embodiments of the present disclosure, the pitch P, the refractive pixel spacing yₖ and the original pixel spacing yₒ satisfy:

$${y}_{k} ( k ) = {\sum }_{i = 0}^{k} P ( k ) + hn tan {θ}_{2} , \qquad ( 1 )$$

$${y}_{0} ( k ) = k \times Δ x , \qquad ( 2 )$$

$${y}_{k} ( k ) - {y}_{0} ( k ) \leq M , \qquad ( 3 )$$

where h is an equivalent air spacing between the cylindrical lens and the display unit, n is a ratio of a refractive index n₂ of the cylindrical lens to a refractive index n₁ of the first medium layer, and θ₂ is an included angle between light and a normal in the cylindrical lens.

In some exemplary embodiments of the present disclosure, in the direction away from the field of view origin along the first direction, the pitches P of the cylindrical lenses increase linearly; and
the pitch P of the k^{th} cylindrical lens is calculated based on the periodic pixel width Δx, the refractive pixel spacing yₖ of the k^{th} cylindrical lens and a pitch Pₒ of a cylindrical lens at the field of view origin.

In some exemplary embodiments of the present disclosure, the pitch P of the k^{th} cylindrical lens satisfies the following linear relationships:

$$P = α \times \frac{{P}_{max} - {P}_{min}}{{k}_{max} - {k}_{min}} \times k , \qquad ( 4 )$$

$${y}_{k} - {y}_{k - 1} = Δ x , \qquad ( 5 )$$

$$Δ x = {P}_{0} \times \frac{{E}_{𝓏} + h}{{E}_{𝓏}} , \qquad ( 6 )$$

where α is a correction coefficient, Pₘᵢₙ=P₀, and Pₘₐₓ is calculated based on the refractive pixel spacing yₖ of the k^{th} cylindrical lens and the pitch P₀ of the cylindrical lens at the field of view origin.

In some exemplary embodiments of the present disclosure, a value range of α is 2.2≤α≤2.6.

In some exemplary embodiments of the present disclosure, in the direction away from the field of view origin along the first direction, the pitches P of the cylindrical lenses increase nonlinearly; and
the pitch P of the k^{th} cylindrical lens is calculated based on the periodic pixel width Δx, the refractive pixel spacing yₖ of the k^{th} cylindrical lens and a pitch P₀ of a cylindrical lens at the field of view origin.

In some exemplary embodiments of the present disclosure, the pitch P of the k^{th} cylindrical lens satisfies:

$${y}_{k} = {\sum }_{i = 0}^{k} P ( k ) + ( \frac{h}{\sqrt{1 - \frac{1}{{n}^{2}} + {( \frac{{E}_{𝓏}}{{\sum }_{i = 0}^{k} P ( k )} )}^{2}}} ) ) , \qquad ( 7 )$$

$${y}_{k} - {y}_{k 1} = Δ x , \qquad ( 8 )$$

$$Δ x = {P}_{0} \times \frac{{E}_{𝓏} + h}{{E}_{𝓏}} , \qquad ( 9 )$$

where k>0.

In some exemplary embodiments of the present disclosure, an absolute value of the difference between the refractive pixel spacing yₖ of the k^{th} cylindrical lens and the original pixel spacing y₀ of the k^{th} cylindrical lens approaches 0.

In some exemplary embodiments of the present disclosure, in the direction away from the field of view origin along the first direction, the pitches P of the cylindrical lenses increase in stages; and
the pitch P of the k^{th} cylindrical lens is calculated based on the preset cylindrical lens number m, the refractive pixel spacing yₖ, the original pixel spacing yₒ and the crosstalk limit M.

In some exemplary embodiments of the present disclosure, in the first direction, the cylindrical lens includes a first cylindrical lens in a first region and a second cylindrical lens in a second region, the first cylindrical lens in the first region has a first pitch P₁, and the second cylindrical lens in the second region has a second pitch P₂,
the first pitch P₁ is less than the second pitch P₂.

In some exemplary embodiments of the present disclosure, the first pitch P₁ of the first cylindrical lens satisfies:

$${y}_{k} ( m ) = {\sum }_{i = 0}^{k} {P}_{1} ( k = m ) + hn tan {θ}_{2} , \qquad ( 10 )$$

$${y}_{0} ( m ) = m \times Δ x , \qquad ( 11 )$$

$${y}_{k} ( m ) - {y}_{o} ( m ) \leq M , \qquad ( 12 )$$

$$Δ x = {P}_{1} \times \frac{{E}_{𝓏} + h}{{E}_{𝓏}} , \qquad ( 13 )$$

where m is the preset number of cylindrical lenses which is known.

In some exemplary embodiments of the present disclosure, in the first direction, a number of cylindrical lenses from the field of view origin to an edge of the first region is kₘₐₓ, and the second pitch P₂ of the second cylindrical lens in the second region satisfies:

$$\{ \begin{matrix}{y}_{k = {k}_{max}} - {k}_{max} Δ x = - M \\ {y}_{k = {k}_{max}} - {k}_{max} Δ x = M \\ Δ x = {P}_{2} \times \frac{{E}_{𝓏} + h}{{E}_{𝓏}}\end{matrix} , \qquad ( 14 )$$

where P₂ is calculated based on Formula (14) and Formula (1).

In some exemplary embodiments of the present disclosure, the hard substrate is disposed on a side close to the base substrate; and
the cylindrical lens has a convex curved surface facing a side away from the base substrate.

In some exemplary embodiments of the present disclosure, the hard substrate is disposed on a side away from the base substrate; and
the cylindrical lens has a convex curved surface facing a side close to the base substrate.

In some exemplary embodiments of the present disclosure, the stereoscopic display substrate further includes:
a second medium layer disposed on a side of the cylindrical lens grating unit away from the base substrate; and
an encapsulation layer disposed on a side of the second medium layer away from the base substrate.

In some exemplary embodiments of the present disclosure, the cylindrical lens is made of a material including organic glass, a hard polycarbonate material, or a soft PET material.

In some exemplary embodiments of the present disclosure, the cylindrical lens grating unit is manufactured by:
coating a cylindrical lens forming material in a cylindrical lens mold;
providing the hard substrate on a side of the cylindrical lens forming material away from the cylindrical lens mold;
pressing the hard substrate so that the cylindrical lens forming material is completely filled in the cylindrical lens mold; and
curing, demoulding, cutting and cleaning the cylindrical lens forming material completely filled in the cylindrical lens mold, so as to form the cylindrical lens grating unit.

In another aspect of embodiments of the present disclosure, a stereoscopic display substrate is provided, including:
a base substrate;
a display unit disposed on a side of the base substrate, where the display unit includes a plurality of pixel units arranged in an array in a first direction and a second direction, the plurality of pixel units have a periodic pixel width Δx in the first direction, and the first direction intersects with the second direction;
a first medium layer disposed on a side of the display unit away from the base substrate;
a cylindrical lens grating unit disposed on a side of the first medium layer away from the base substrate, where the cylindrical lens grating unit includes a hard substrate and a plurality of cylindrical lenses contiguously arranged in the first direction, and each of the plurality of cylindrical lenses has a pitch P,
where the stereoscopic display substrate has a preset field of view position with an optimal display effect in a third direction, and the third direction is perpendicular to the first direction and the second direction;
in a direction away from a field of view origin along the first direction, pitches P of the cylindrical lenses are equal, and a spacing between the preset field of view position and the field of view origin in the third direction is E_{z};
the pitch P of each of the plurality of cylindrical lenses is calculated based on a preset cylindrical lens number m of the plurality of cylindrical lenses, a refractive pixel spacing yₖ, an original pixel spacing yₒ and a crosstalk limit M, and the refractive pixel spacing yₖ is a spacing between a pixel unit corresponding to a k^{th} cylindrical lens and the field of view origin in a case of taking cylindrical lens refraction into account, k being an integer greater than 0; and
a difference between the refractive pixel spacing yₖ and the original pixel spacing yₒ of the cylindrical lens is less than or equal to the crosstalk limit M, the crosstalk limit is associated with a pitch of the pixel unit in the first direction, and the original pixel spacing yₒ is a spacing between the pixel unit corresponding to the k^{th} cylindrical lens and the field of view origin in a case of not taking the cylindrical lens refraction into account.

In yet another aspect of the present disclosure, a display apparatus is further provided, including the above-mentioned display substrate.

### BRIEF DESCRIPTION OF THE DRAWINGS

Other objects and advantages of the present disclosure will be apparent from the following descriptions of the present disclosure with reference to the accompanying drawings, which may provide a comprehensive understanding of the present disclosure.

FIG. 1A schematically shows a schematic stereoscopic structural diagram of a stereoscopic display substrate according to an exemplary embodiment of the present disclosure;

FIG. 1B schematically shows a schematic diagram of a relationship between an actual periodic pixel width and a theoretical periodic pixel width of a stereoscopic display substrate according to an exemplary embodiment of the present disclosure;

FIG. 1C schematically shows a schematic diagram of refraction of a cylindrical lens of a stereoscopic display substrate according to an exemplary embodiment of the present disclosure;

FIG. 2A schematically shows a schematic structural diagram of a cross-section of a stereoscopic display substrate according to an exemplary embodiment of the present disclosure;

FIG. 2B schematically shows a diagram showing a variation relationship between a periodic pixel width and a number of cylindrical lenses of the stereoscopic display substrate in FIG. 2A;

FIG. 3A schematically shows a schematic cross-sectional structural diagram of a stereoscopic display substrate according to another exemplary embodiment of the present disclosure;

FIG. 3B schematically shows a diagram of a variation relationship between a crosstalk rate and a number of cylindrical lenses of the stereoscopic display substrate in FIG. 3A;

FIG. 4A schematically shows a schematic cross-sectional structural diagram of a stereoscopic display substrate according to yet another exemplary embodiment of the present disclosure;

FIG. 4B schematically shows a diagram of a variation relationship between a crosstalk rate and a number of cylindrical lenses of the stereoscopic display substrate in FIG. 4A;

FIG. 5A schematically shows a schematic cross-sectional structural diagram of a stereoscopic display substrate according to yet another exemplary embodiment of the present disclosure;

FIG. 5B schematically shows a diagram of a variation relationship between a crosstalk rate and a number of cylindrical lenses of the stereoscopic display substrate in FIG. 5A;

FIG. 6A schematically shows a cross-sectional structural schematic diagram of a stereoscopic display substrate according to yet another exemplary embodiment of the present disclosure;

FIG. 6B schematically shows a diagram of a variation relationship between a crosstalk rate and a number of cylindrical lenses of the stereoscopic display substrate in FIG. 6A; and

FIG. 7 schematically shows a flowchart of manufacturing a cylindrical lens grating unit.

It will be noted that, for the sake of clarity, in the accompanying drawings used to describe the embodiments of the present disclosure, a size of a layer, a structure or a region may be enlarged or reduced, that is, the drawings may not be drawn to actual scales.

### DETAILED DESCRIPTION OF EMBODIMENTS

The technical solutions of the present disclosure will be further described in detail below through embodiments of the present disclosure with reference to the accompanying drawings. In the specification, the same or similar reference numerals indicate the same or similar components. The following descriptions of the embodiments of the present disclosure with reference to the accompanying drawings are intended to explain the general inventive concept of the present disclosure and should not be construed as limiting the present disclosure.

In addition, in the following detailed descriptions, for the convenience of explanation, many specific details are set forth to provide a comprehensive understanding for the embodiments of the present disclosure. However, it is obvious that one or more embodiments may also be implemented without these specific details.

It will be noted that although terms “first”, “second”, etc. may be used here to describe various parts, components, elements, regions, layers and/or portions, these parts, components, elements, regions, layers and/or portions should not be limited by these terms. Rather, these terms are used to distinguish one part, component, element, region, layer and/or portion from another one. Accordingly, for example, a first part, a first component, a first element, a first region, a first layer and/or a first portion as discussed below may be referred to as a second part, a second component, a second element, a second region, a second layer and/or a second portion without departing from the teachings of the present disclosure.

For the convenience of description, spatial relational terms such as “up”, “down”, “left”, “right”, etc. may be used here to describe the relationship between one element or feature and another element or feature as shown in the drawings. It will be understood that the spatial relational terms are intended to cover different orientations of an apparatus in use or operation besides those described in the drawings. For example, if the apparatus in the drawings is reversed, an element described as being located “under” or “below” another element or feature may be oriented to be located “on” or “above” the other element or feature.

Terms “substantially”, “about”, “approximately”, “roughly” and other similar terms used herein are used as approximate terms rather than terms of degree, and they are intended to explain inherent deviations of measured values or calculated values that will be recognized by those skilled in the art. In consideration of factors such as process fluctuations, measurement problems and errors related to measurement of particular quantities (i.e., the limitation of the measurement system), “about” or “approximately” used herein means that a stated value is included and that a determined particular value is within an acceptable deviation range of those skilled in the art. For example, “about” may mean that a value is within one or more standard deviations, or within ±30%, ±20%, ±10%, and ±5% of the stated value.

It will be noted that the expression “the same layer” used herein refers to a layer structure formed by forming a film layer for formation of a specific pattern through a same film forming process, and then performing one patterning process on the film layer using a mask. According to different specific patterns, the patterning process may include a plurality of exposure, development or etching processes, and the specific patterns of the formed layer structure may be continuous or discontinuous. That is, a plurality of elements, parts, structures and/or portions in “the same layer” are made of the same material and formed through the same patterning process. Generally, the plurality of elements, parts, structures and/or portions in the “same layer” have approximately the same thickness.

Those skilled in the art will understand that, unless otherwise specified, expressions “continuous extension”, “integral structure”, “whole structure” or the like used herein mean that a plurality of elements, parts, structures and/or portions are in the same layer and are usually formed through the same patterning process during manufacturing, and these elements, parts, structures and/or portions are continuously extending structures without gaps or breaks therebetween.

Directional expressions “first direction” and “second direction” are used to describe different directions along a pixel region, for example, a longitudinal direction and a lateral direction of the pixel region. It will be understood that such expressions are only exemplary descriptions, and are not intended to limit the present disclosure.

The term “periodic pixel width” used herein refers to a pitch of an image or a picture displayed by the display unit and seen by a viewer's left eye or right eye after being refracted by one of cylindrical lenses of a cylindrical lens grating unit, and each periodic pixel width refers to a pitch of the display unit seen by the viewer's left eye or right eye through one cylindrical lens, where images or pictures seen by the left eye and the right eye are alternately displayed on the display unit.

The term “preset field of view position” used herein refers to a position where a viewer may have an optimal view for the stereoscopic display substrate in the embodiments of the present disclosure. That is, when the viewer's left eye or right eye is located at the preset field of view position, he or she may have the optimal view for the display image, and the effect of preventing crosstalk according to the embodiments of the present disclosure may be achieved.

The term “refractive pixel spacing” used herein refers to a spacing between a pixel unit corresponding to each cylindrical lens and a field of view origin in a case of taking the refraction by the cylindrical lens into account.

The term “original pixel spacing” used herein refers to a spacing between the pixel unit corresponding to each cylindrical lens and the field of view origin in a case of not taking the refraction by the cylindrical lens into account.

The term “pitch” used herein refers to a pitch of a cylindrical lens in the cylindrical lens grating unit in a first direction.

The existing stereoscopic display devices available on the market have the problem of crosstalk and ghosting, especially when viewed from a large viewing angle region. The main reason is that in the design of the display devices, the fact that different positions of the cylindrical lenses relative to the human eye result in different degrees of refraction is not taken into account. In addition, a base material of cylindrical lenses of the stereoscopic display devices available on the market is, for example, a PET soft film material, and when the cylindrical lenses are attached to the display unit, the cylindrical lenses may fail to completely attached to the display unit due to large process fluctuations, which may further increase a global crosstalk of the display device, resulting in a poor display effect of the existing stereoscopic display devices.

In order to solve the above-mentioned problems, the embodiments of the present disclosure provide a stereoscopic display substrate, including but not limited to: a base substrate; a display unit disposed on a side of the base substrate, where the display unit includes a plurality of pixel units, the plurality of pixel units are arranged in an array in a first direction and a second direction, the plurality of pixel units have a periodic pixel width Δx in the first direction, and the first direction intersects with the second direction; a first medium layer disposed on a side of the display unit away from the base substrate; and a cylindrical lens grating unit disposed on a side of the first medium layer away from the base substrate, where the cylindrical lens grating unit includes a hard substrate and a plurality of cylindrical lenses contiguously arranged in the first direction, and each of the plurality of cylindrical lenses has a pitch P. The stereoscopic display substrate has a preset field of view position with an optimal display effect in a third direction, and the third direction is perpendicular to both the first direction and the second direction; in a direction away from the a field of view origin along the first direction, pitches P of the cylindrical lenses increase, the field of view origin is an intersection of the third direction, the first direction and the second direction, and a spacing between the preset field of view position and the field of view origin in the third direction is E_{z}; the pitch P of each cylindrical lens is calculated based on a refractive pixel spacing yₖ and at least one of a preset cylindrical lens number m of the plurality of cylindrical lenses and the periodic pixel width Δx, and the refractive pixel spacing yₖ is a spacing between a pixel unit corresponding to a k^{th} cylindrical lens and the field of view origin in a case of taking cylindrical lens refraction into account, where k is an integer greater than 0. A difference between the refractive pixel spacing yₖ and an original pixel spacing yₒ of the cylindrical lens is less than or equal to a crosstalk limit M associated with a pitch of the pixel unit in the first direction, and the original pixel spacing yₒ is a spacing between the pixel unit corresponding to the k^{th} cylindrical lens and the field of view origin in a case of not taking the cylindrical lens refraction into account.

According to the embodiments of the present disclosure, the cylindrical lens grating unit is provided with the hard substrate, so that the cylindrical lens grating unit may be effectively attached to the display unit, thereby reducing the crosstalk caused by process fluctuations. Furthermore, the pitches of the cylindrical lenses in the cylindrical lens grating unit are configured to increase in the direction away from the field of view origin, so that it is possible to effectively alleviate or completely eliminate the crosstalk caused by the cylindrical lens refraction during the display of the stereoscopic display substrate, thereby effectively improving the display effect of the stereoscopic display substrate.

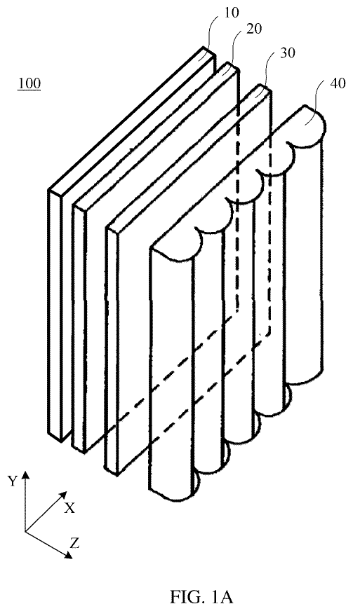

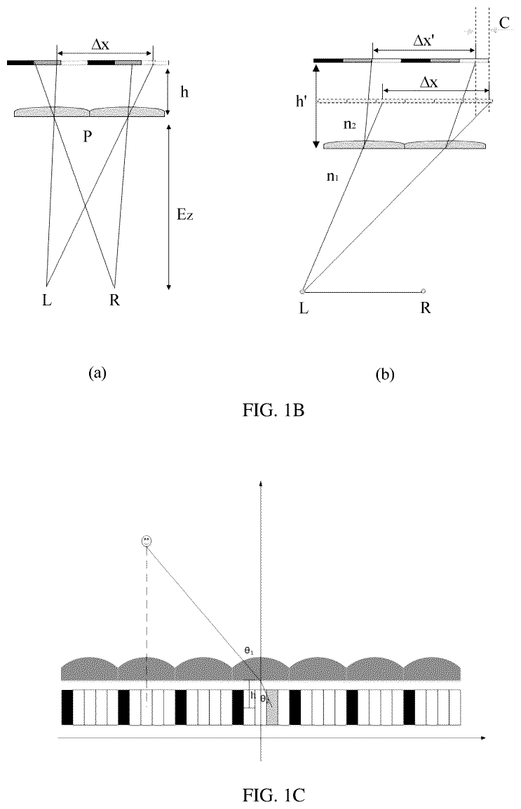

The stereoscopic display substrate according to the embodiments of the present disclosure will be described in detail below with reference to FIG. 1A to FIG. 7.

FIG. 1A schematically shows a schematic stereoscopic structural diagram of a stereoscopic display substrate according to an exemplary embodiment of the present disclosure. FIG. 1B schematically shows a schematic diagram of a relationship between an actual periodic pixel width and a theoretical periodic pixel width of a stereoscopic display substrate according to an exemplary embodiment of the present disclosure. FIG. 1C schematically shows a schematic diagram of refraction of a cylindrical lens of a stereoscopic display substrate according to an exemplary embodiment of the present disclosure.

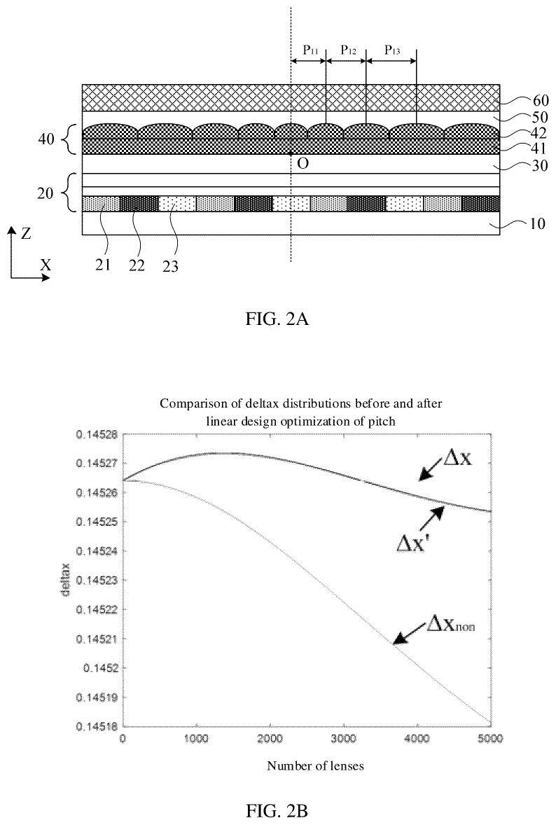

FIG. 2A schematically shows a schematic structural diagram of a cross-section of a stereoscopic display substrate according an exemplary embodiment of the present disclosure.

As shown in FIG. 1A, FIG. 1B and FIG. 2A, the stereoscopic display substrate includes a base substrate 10, a display unit 20, a first medium layer 30 and a cylindrical lens grating unit 40.

The base substrate 10 may be, for example, a glass substrate. The display unit 20 is disposed on a side of the base substrate 10, the display unit 20 includes a plurality of pixel units for displaying different images, and each pixel unit may include a plurality of sub-pixels, such as a first sub-pixel 21, a second sub-pixel 22 and a third sub-pixel 23. For example, the first sub-pixel 21 may be a red sub-pixel, the second sub-pixel 22 may be a blue sub-pixel, and the third sub-pixel 23 may be a green sub-pixel. In other alternative embodiments of the present disclosure, the number of sub-pixels may also be other suitable numbers, which will not be limited in the present disclosure.

As shown in FIG. 1A, the plurality of pixel units are arranged in an array in a first direction X and a second direction Y, where the first direction X intersects with the second direction Y. The plurality of pixel units have a periodic pixel width Δx in the first direction X, namely a pitch of pixels seen by a viewer's left eye or right eye through each cylindrical lens, where the pixels are displayed on the display unit. The periodic pixel width Δx is related to an observation viewing angle and a spacing between the viewer's left eye or right eye and the cylindrical lens. The first direction X and the second direction Y forms a plane parallel to a plane where the base substrate 10 is located. The base substrate 10, the display unit 20, the first medium layer 30 and the cylindrical lens grating unit 40 are arranged in a stack in a third direction Z, where the third direction Z is perpendicular to both the first direction X and the second direction Y.

For example, the first medium lay 30 may be used to attach the display unit to the cylindrical lens grating unit. For example, the first medium layer 30 includes an OCA (optically clear adhesive).

As shown in FIG. 2A, the cylindrical lens grating unit 40 is disposed on a side of the first medium layer 30 away from the base substrate. The cylindrical lens grating unit 40 includes a hard substrate 41 and a plurality of cylindrical lenses contiguously arranged in the first direction, a cylindrical lens in the plurality of cylindrical lenses has a pitch P. According to the embodiments of the present disclosure, the crosstalk of the stereoscopic display substrate may be alleviated or completely eliminated through a design of the pitch P.

The embodiments of the present disclosure will be described in detail below in combination with a design principle of the pitch of the cylindrical lens in the first direction.

In the stereoscopic display apparatus, in a general layout algorithm, for cylindrical lenses disposed at different positions, a relationship between a periodic pixel width Δx corresponding to the cylindrical lens calculated based on the position of human eyes and a pitch P of the cylindrical lens is shown in Formula (1). That is, the periodic pixel width Δx corresponding to the cylindrical lens and the pitch P are fixed values.

$$\frac{Δ x}{P} = \frac{{E}_{𝓏} + h}{{E}_{𝓏}} \qquad Formula ( 1 )$$

As shown in (a) of FIG. 1B, E_{z} represents a spacing between the viewer's eyes and the cylindrical lenses in the third direction Z, L represents a left eye in human eyes, and R represents a right eye in human eyes. In actual viewing, the left eye and the right eye of the human eyes may see the pixels of the periodic pixel width corresponding to each cylindrical lens, and the left eye and the right eye see different displayed patterns in the periodic pixel width, so that human eyes may see a stereoscopic image. Here, h is an equivalent air spacing between the cylindrical lens and the display unit. As shown in (b) of FIG. 1B, the equivalent air spacing h may be calculated based on an actual spacing h′ between the cylindrical lens and the display unit.

In the actual display, assuming that the left eye L (or the right eye) of the human eyes is at the field of view origin, due to the presence of refraction, an actual periodic pixel width Δx′ that the human eyes are actually capable of seeing decreases as a distance between the cylindrical lens and the human eyes in the first direction X increases. Therefore, it is necessary to fully consider: a spacing between the pixel unit corresponding to the cylindrical lens and the field of view origin in the case of refraction, namely the refractive pixel spacing yₖ, and a spacing between the pixel unit corresponding to the cylindrical lens and the field of view origin in a case of not taking refraction of the cylindrical lens into account, namely the original pixel spacing yₒ. That is, it is necessary to determine whether the crosstalk exits based on a difference between the refractive pixel spacing yₖ and the original pixel spacing yₒ.

According to the principle of refraction, a value of the refractive pixel spacing yₖ may be calculated using Formula (2):

$${y}_{k} ( k ) = {\sum }_{i = 0}^{k} P ( k ) + hn tan {θ}_{2} \qquad Formula ( 2 )$$

Here, h is the equivalent air spacing between the cylindrical lens and the display unit, and n is a ratio of a refractive index n₂ of the lens to a refractive index n₁ of a medium around the lens.

As shown in FIG. 1C, in a case of taking an angle θ₁ of light in the medium around the cylindrical lens and an angle θ₂ of the light in the cylindrical lens into account, Formula (2) is converted based on a conversion relationship between the refractive index and the angle, i.e., Formula (3) and Formula (4), so as to obtain Formula (5):

$$sin {θ}_{1} \times {n}_{1} = sin {θ}_{2} \times {n}_{2} , \qquad Formula ( 3 )$$

$$n = \frac{{n}_{2}}{{n}_{1}} , \qquad Formula ( 4 )$$

$${y}_{k} ( k ) = {\sum }_{i = 0}^{k} P ( k ) + hn tan ( arcsin ( \frac{1}{n} \times \frac{{\sum }_{i = 0}^{k} P ( k ) - {E}_{x}}{\sqrt{{( {\sum }_{i = 0}^{k} P ( k ) - {E}_{x} )}^{2} + {E}_{z}^{2}}} ) ) . \qquad Formula ( 5 )$$

Here, h is the equivalent air spacing between the cylindrical lens and the display unit, and the equivalent air spacing h may be calculated based on the actual spacing h′ between the cylindrical lens and the display unit. That is, starting from the field of view origin, a refractive pixel spacing yₖ(k) between the pixel unit corresponding to the k^{th} cylindrical lens and the field of view origin may be calculated using Formula (5).

The original pixel spacing yₒ may be obtained using Formula (6):

$${y}_{o} ( k ) = k \times Δ x , \qquad Formula ( 6 )$$

$$Δ x = {P}_{0} \times \frac{{E}_{𝓏} + h}{{E}_{𝓏}} . \qquad Formula ( 7 )$$

An original pixel spacing yₒ(k) between the pixel unit corresponding to the k^{th} cylindrical lens and the field of view origin may be calculated using Formula (6) and Formula (7).

In the embodiments of the present disclosure, through the design of the pitches of the cylindrical lenses, it is possible to reduce the crosstalk and enable the actual periodic pixel width Δx′ to approach the theoretical periodic pixel width Δx, so that the problem of inconsistency of the actual periodic pixel width Δx′ and the theoretical periodic pixel width Δx may be solved, thus the reduction of the crosstalk may be achieved, which may be beneficial to improving the display effect of the display substrate.

For example, the stereoscopic display substrate in the present disclosure has a preset field of view position with an optimal display effect in the third direction. For example, the preset field of view position is set at a central position of the stereoscopic display substrate, and a distance between the preset field of view position and the cylindrical lens in the third direction is E_{z}. For example, the first direction X, the second direction Y and the third direction Z intersect at the central position of the stereoscopic display substrate, and the intersection serves as the field of view origin O, and thus a spacing between the preset field of view position and the field of view origin in the third direction Z is E_{z}.

The cylindrical lens grating unit 40 of the present disclosure includes a plurality of cylindrical lenses 42 contiguously arranged in the first direction X, and pitches P of the cylindrical lenses increase in a direction away from the field of view origin O. For example, the pitches P of the cylindrical lenses increase linearly; or the pitches P of the cylindrical lenses increase nonlinearly; or the pitches P of the cylindrical lenses increase in stages, that is, there are regions of a plurality of pitches, such as a first region close to the field of view origin O and a second region away from the field of view origin O, and pitches P₁ of adjacent cylindrical lenses in the first region are less than pitches P₂ of adjacent cylindrical lenses in the second region.

In the embodiments of the present disclosure, when the difference between the refractive pixel spacing yₖ(k) and the original pixel spacing yₒ(k) exceeds the crosstalk limit, it is considered that a crosstalk occurs in the display substrate. A crosstalk rate is calculated using Formula (8):

$$rate ( k ) = \frac{\vert {y}_{k} ( k ) - {y}_{o} ( k ) \vert}{M} . \qquad Formula ( 8 )$$

That is, when rate(k)≤1, it is considered that no crosstalk occurs, and when the rate(k)>1, it is indicated that a crosstalk occurs in the display substrate.

In the embodiments of the present disclosure, the crosstalk limit M is associated with the pitch of the pixel unit in the first direction. For example, M is determined to be ⅔ of the pixel pitch, that is, ⅔ pixel. In other alternative embodiments, the crosstalk limit M may be specifically determined according to an actual display effect. For example, if a display substrate with a better display effect is required, M may be less than the above value.

In some embodiments of the present disclosure, the pitch P of each cylindrical lens is calculated based on the refractive pixel spacing yₖ and at least one of the preset cylindrical lens number m of the cylindrical lenses and the periodic pixel width Δx. For example, the pitch P is calculated based on the preset cylindrical lens number m and the refractive pixel spacing yₖ. For another example, the pitch P may be calculated based on the periodic pixel width and the refractive pixel spacing yₖ. A difference between the refractive pixel spacing yₖ and the original pixel spacing yₒ of the cylindrical lens is less than or equal to the crosstalk limit M, and the crosstalk limit M is associated with the pitch of the pixel unit in the first direction, for example, the crosstalk limit M is equal to ⅔ pixel.

A cylindrical lens pitch P will be described in detail below with reference to the embodiment in FIG. 2A.

As shown in FIG. 2A, the stereoscopic display substrate includes a base substrate 10, a display unit 20, a first medium layer 30, a cylindrical lens grating unit 40, a second medium layer 50 and an encapsulation layer 60.

For example, the cylindrical lens grating unit 40 includes a hard substrate 41 and a plurality of cylindrical lenses 42. The hard substrate 41 is disposed on a side close to the base substrate 10. The cylindrical lens 42 is disposed on a side away from the base substrate 10. The cylindrical lens has a convex curved surface, and the convex curved surface faces a side away from the base substrate.

The first medium layer 30 is used to attach the display unit 20 to the cylindrical lens grating unit 40.

The second medium layer 50 is disposed on a side of the cylindrical lens grating unit away from the base substrate. The encapsulation layer 60 is disposed on a side of the second medium layer away from the base substrate.

For example, the second medium layer 50 may be made of the same material as the first medium layer 30, or other medium materials. For example, the second medium layer 50 may be made of a material with a low refractive index. The encapsulation layer 60 is used to encapsulate and protect the stereoscopic display substrate, so as to prevent damage to internal film layers of the display substrate from the environment. In other alternative embodiments, the second medium layer 50 and the encapsulation layer 60 may be optional.

In the embodiments shown in FIG. 2A, in the direction away from the field of view origin along the first direction X, the pitches P of the cylindrical lenses increase linearly; the pitch P of each cylindrical lens is calculated based on the periodic pixel width Δx, the refractive pixel spacing yₖ of the k^{th} cylindrical lens and a pitch P₀ of a cylindrical lens at the field of view origin.

For example, starting from the field of view origin O, the pitches P of the cylindrical lenses in the direction away from the field of view origin O in the first direction X satisfies:

$$P = α \times \frac{{P}_{max} - {P}_{min}}{{k}_{max} - {k}_{min}} \times k . \qquad Formula ( 9 )$$

Here, α is a correction coefficient, which is used to adjust a slope of a pitch variation of the cylindrical lens, so that linearly varying pitches of the cylindrical lenses may be obtained, which may alleviate or eliminate the crosstalk, thereby achieving a better display effect of the stereoscopic display substrate.

Here, Pₘᵢₙ refers to a minimum pitch of the cylindrical lenses. In the embodiments, the minimum pitch Pₘᵢₙ of the cylindrical lenses is calculated based on Formula (1).

That is, Pₘᵢₙ is calculated based on

$${P}_{min} = \frac{Δ {xE}_{𝓏}}{{E}_{𝓏} - h} ,$$

where Δx is a known determined value.

Based on this, since the periodic pixel width Δx of the display unit of the stereoscopic display substrate is unchanged, actual periodic pixel widths Δx′ of the cylindrical lenses are equal in the case of taking the refraction into account, and Pₘₐₓ is calculated based on above Formula (5) and following Formula (10) and Formula (11).

$$Δ {x}^{′} = {y}_{k} ( k ) - {y}_{k} ( k - 1 ) , \qquad Formula ( 10 )$$

$$Δ {x}^{′} = {P}_{0} \times \frac{{E}_{𝓏} + h}{{E}_{𝓏}} . \qquad Formula ( 11 )$$

By determining the number k of cylindrical lenses of the stereoscopic display substrate from the field of view origin O to a side of the display substrate in the first direction X, Pₘₐₓ may be determined based on Formula 5, Formula 10 and Formula 11. In the embodiments of the present disclosure, the display effect of the display substrate is simulated by adjusting a range of the correction coefficient α, so that an optimal correction coefficient α is obtained, and P that tends to increase linearly is determined based on the correction coefficient α.

FIG. 2B schematically shows a diagram of a variation relationship between a periodic pixel width and a number of cylindrical lenses of the stereoscopic display substrate in FIG. 2A.

For example, a value range of the correction coefficient α is 2.2≤α≤2.6. For example, when the correction coefficient α is 2.5, the distribution of the periodic pixel width Δx′ of the cylindrical lens calculated in the case of taking the actual refraction into account is the most similar to a distribution of the theoretical periodic pixel width Δx. As shown in FIG. 2B, the colors of the periodic pixel width Δx′ of the cylindrical lens calculated in the case of taking the actual refraction calculation into account, a periodic pixel width ΔXₙₒₙ of the cylindrical lens calculated in the case of not taking the actual refraction calculation into account and the theoretical periodic pixel width Δx gradually deepen. It may be seen from FIG. 2B that the periodic pixel width Δxₙₒₙ of the cylindrical lens calculated in the case of not taking the actual non-refraction into account decreases as the spacing between the cylindrical lens and the field of view origin O increases. Based on this, in order to reduce the crosstalk between pixels, the pitch of the cylindrical lens is designed to linearly vary, so as to reduce a difference between the actual periodic pixel width of the cylindrical lens and the theoretical periodic pixel width. As shown in FIG. 2B, the distribution of the periodic pixel width Δx′ of the cylindrical lens calculated in the case of taking the actual refraction into account is the most similar to a distribution of the theoretical periodic pixel width Δx.

In the embodiments, assuming that the preset field of view position is (0,0,700), i.e. the spacing E_{z} between the human eyes and the cylindrical lens is 700 mm, and that the number of cylindrical lenses between the field of view origin O of the cylindrical lens grating unit and the side of the cylindrical lens grating unit in the first direction X is 5000, then Pₘᵢₙ may be calculated based on the above calculation formula of Pₘᵢₙ to be equal to 01145100 mm, and Pₘₐₓ may be calculated based on the above Formula 5, Formula 10 and Formula 11 to be equal to 0145172 mm.

The value of P is then calculated based on Formula (9), Pₘᵢₙ and Pₘₐₓ.

As shown in FIG. 2A, in the embodiments, the pitches of adjacent cylindrical lenses change linearly, and the pitches of the adjacent cylindrical lenses satisfy: P₁₂−P₁₁=P₁₃−P₁₂.

In the embodiments, the crosstalk rate of the cylindrical lenses is calculated based on Formula (8) in the case of setting the pitches P of adjacent cylindrical lenses to increase linearly, i.e.,

$$rate ( k ) = \frac{\vert {y}_{k} ( k ) - {y}_{o} ( k ) \vert}{M} .$$

In this case, the calculated crosstalk rate is less than 1. Thus, when the number of cylindrical lenses from the field of view origin O to a side of the cylindrical lens grating unit is known, the crosstalk of the stereoscopic display substrate may be effectively alleviated or even eliminated by setting the pitches P of the cylindrical lenses to change linearly.

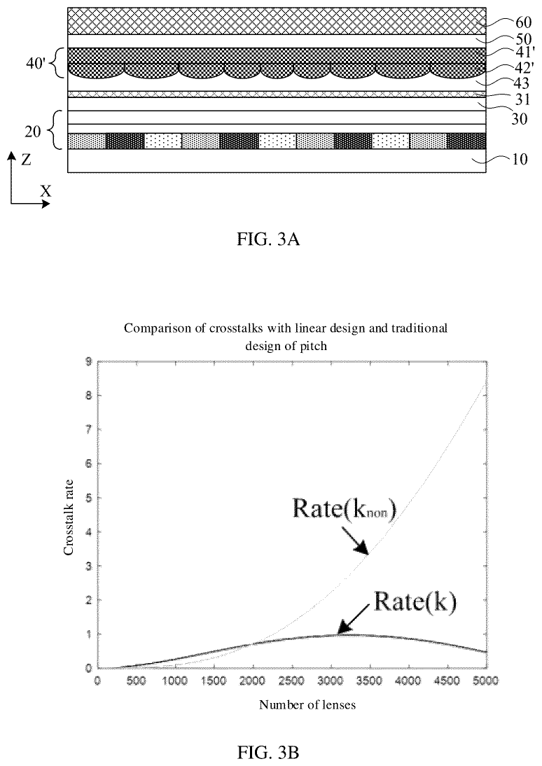

FIG. 3A schematically shows a schematic cross-sectional structural diagram of a stereoscopic display substrate according to another exemplary embodiment of the present disclosure. FIG. 3B schematically shows a diagram of a variation relationship between a crosstalk rate and a number of cylindrical lenses of the stereoscopic display substrate in FIG. 3A.

As shown in FIG. 3A, the stereoscopic display substrate includes a base substrate 10, a display unit 20, a first medium layer 30, a cylindrical lens grating unit 40′, a second medium layer 50 and an encapsulation layer 60.

For example, the cylindrical lens grating unit 40′ includes a hard substrate 41′ and a plurality of cylindrical lenses 42′. The hard substrate 41′ is disposed on a side away from the base substrate 10; the cylindrical lens 42′ is disposed on a side close to the base substrate 10. The cylindrical lens has a convex curved surface, and the convex curved surface faces the side close to the base substrate.

The first medium layer 30 is used to attach the display unit 20 to the cylindrical lens grating unit 40.

In the embodiments, a glass substrate 31 is further provided between the first medium layer 30 and the cylindrical lens grating unit 40′. The glass substrate 31 is used to flatten a region between the cylindrical lens grating unit 40′ and the display unit 20, so as to prevent a crosstalk caused by process fluctuations during the attachment process.

In the embodiments, the cylindrical lens grating unit 40′ is oriented in an opposite direction to the cylindrical lens grating unit 40, and the pitch P between adjacent cylindrical lenses 42′ of the cylindrical lens grating unit 40′ is calculated based on the above Formula (9). Pₘᵢₙ and Pₘₐₓ are calculated in the same way as described above, and the pitch P of the cylindrical lens in the cylindrical lens grating unit of the display substrate with this structure is then obtained based on the pitch Pₘᵢₙ and the pitch Pₘₐₓ.

As shown in FIG. 3B, a crosstalk rate in a case of applying the linear design to the pitches of the cylindrical lenses in the cylindrical lens grating unit is rate(k), a crosstalk rate in a case of not applying the design to the pitches of the cylindrical lenses in the cylindrical lens grating unit is rate(kₙₒₙ), and it may be seen from the figure that the crosstalk rate of the stereoscopic display substrate in the case of applying the linear design to the pitches of the cylindrical lenses is less than 1, while the crosstalk rate of the stereoscopic display substrate in a case of not applying the design to the pitches of the cylindrical lenses gradually increases after the number of cylindrical lenses exceeds a certain number. For example, as shown in FIG. 3B, without applying the design to the pitches of the cylindrical lenses, when the number of cylindrical lenses exceeds 2300, the crosstalk rate of the stereoscopic display substrate is greater than 1 and tends to increase nonlinearly. Therefore, in the embodiments, by setting the pitches of the cylindrical lenses of the cylindrical lens grating unit to increase linearly in the direction away from the field of view origin, the crosstalk may be alleviated or even eliminated, so that the display effect of the stereoscopic display substrate may be effectively improved.

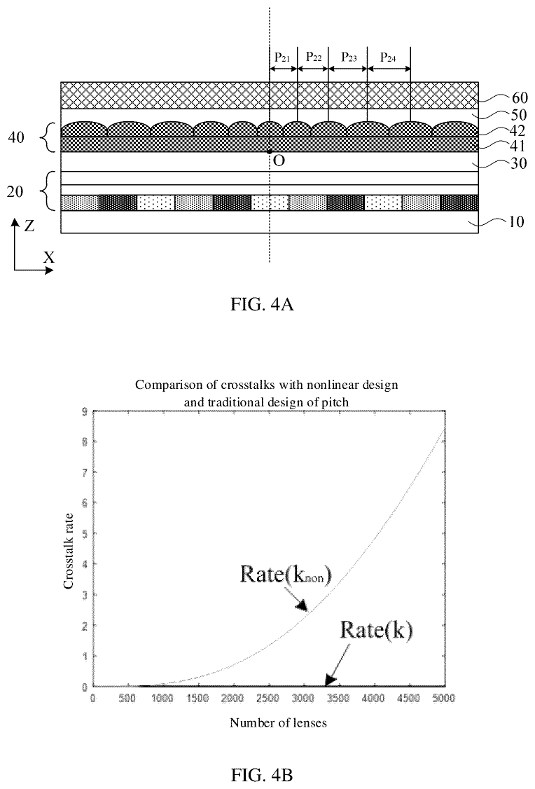

FIG. 4A schematically shows a schematic cross-sectional structural diagram of a stereoscopic display substrate according yet another exemplary embodiment of the present disclosure. FIG. 4B schematically shows a diagram of a variation relationship between a crosstalk rate and a number of cylindrical lenses of the stereoscopic display substrate in FIG. 4A.

As shown in FIG. 4A, in this embodiment, in the direction away from the field of view origin along the first direction X, the pitches P of the cylindrical lenses increase nonlinearly. The pitches P of a k^{th} cylindrical lens is calculated based on the periodic pixel width Δx, the refractive pixel spacing yₖ of the k^{th} cylindrical lens and the pitch P₀ of the cylindrical lens at the field of view origin.

For example, the stereoscopic display substrate includes a base substrate 10, a display unit 20, a first medium layer 30, a cylindrical lens grating unit 40, a second medium layer 50, and an encapsulation layer 60.

The refraction based on a human eye position is taken into account to calculate a periodic pixel width Δx′ of each cylindrical lens, and a pitch P of each cylindrical lens is determined based on a respective periodic pixel width. When the human eye is located at the preset field of view position, a distance Ex of the human eye in the first direction X is 0, that is, Eₓ=0.

Eₓ=0 is substituted into the above Formula (5) and coordinate transformation is performed on Formula (5), where k>0, and k represents the k^{th} cylindrical lens from the field of view origin where the human eyes are located.

Coordinate transformation is performed on the above Formula (5) to obtain the following Formula (12). That is, the pitch P of the k^{th} cylindrical lens satisfies:

$${y}_{k} = {\sum }_{i = 0}^{k} {P}_{k} ( k ) + ( \frac{h}{\sqrt{1 - \frac{1}{{n}^{2}} + {( \frac{{E}_{𝓏}}{{\sum }_{i = 0}^{k} {P}_{k} ( k )} )}^{2}}} ) ) \qquad Formula ( 12 )$$

A refractive pixel spacing yₖ and a periodic pixel width Δx′ corresponding to each cylindrical lens are obtained based on Formula (10), Formula (11) and Formula (12). By setting the pixel periodic pitch Δx′ to be the same as a periodic pixel width Δx of adjacent cylindrical lenses at the field of view origin O, the crosstalk may be completely eliminated.

A pitch P of each cylindrical lens may be calculated based on the above Formula (10), Formula (11) and Formula (12).

For example, when the number of cylindrical lenses from the field of view origin O to a side of the cylindrical lens grating unit is known, for example, the number of cylindrical lenses is 5000, then P₀ and Pₘₐₓ are calculated using the above method to be 0.1451 mm and 0.145183 mm respectively. A pitch of adjacent cylindrical lenses from the remaining cylindrical lenses is in a range of 0.1451 mm<P<0.145183 mm, and the pitches P of the cylindrical lenses calculated based on the above formulas increase nonlinearly in the direction away from the field of view origin within the above range.

As shown in FIG. 4A, P₂₂−P₂₁<P₂₃−P₂₂<P₂₄−P₂₃. That is, the pitches P of the cylindrical lenses increase nonlinearly in the range from the field of view origin O to a side of the cylindrical lens grating unit.

In this embodiment, an absolute value of the difference between the refractive pixel spacing yₖ of the k^{th} cylindrical lens and the original pixel spacing yₒ of the k^{th} cylindrical lens approaches 0. That is, by designing the pitch of the cylindrical lens to vary nonlinearly, the periodic pixel width Δx′ when taking the cylindrical lens refraction into account may be the same as the theoretical periodic pixel width Δx, so that it is possible to achieve a complete elimination of the crosstalk.

As shown in FIG. 4B, a crosstalk rate in the case of applying the nonlinear design to the pitches of the cylindrical lenses in the cylindrical lens grating unit is rate(k), a crosstalk rate in a case of not applying the design to the pitches of the cylindrical lenses in the cylindrical lens grating unit is rate(kₙₒₙ). By designing the pitches of the cylindrical lenses in this way, it is possible to achieve that the periodic pixel width Δx′ of each cylindrical lens calculated in the case of taking the actual refraction into account is the same as the theoretical periodic pixel width Δx. That is, the crosstalk rate calculated based on Formula (8) is 0, as shown in FIG. 4B. Therefore, by designing the pitch of the cylindrical lens of the cylindrical lens grating unit to vary nonlinearly, the crosstalk may be completely eliminated and the display effect of the stereoscopic display substrate may be effectively improved.

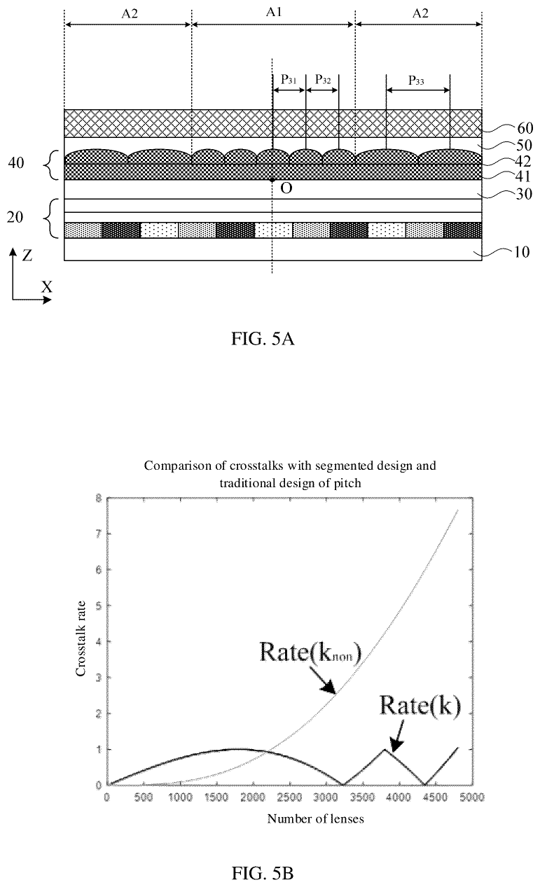

FIG. 5A schematically shows a schematic cross-sectional structural diagram of a stereoscopic display substrate according to yet another exemplary embodiment of the present disclosure. FIG. 5B schematically shows a diagram of a variation relationship between a crosstalk rate and a number of cylindrical lenses of the stereoscopic display substrate in FIG. 5A.

As shown in FIG. 5A, in the direction away from the field of view origin along the first direction, the pitches P of the cylindrical lenses increase in stages. The pitch P of the k^{th} cylindrical lens is calculated based on the preset cylindrical lens number m, the refractive pixel spacing yₖ, the original pixel spacing yₒ and the crosstalk limit M.

For example, the preset total number m of the cylindrical lenses of the stereoscopic display substrate is known. In the first direction X, the cylindrical lens includes a first cylindrical lens located in a first region and a second cylindrical lens located in a second region. A pitch of the first cylindrical lens in the first region is a first pitch P₁, a pitch of the second cylindrical lens in the second region is a second pitch P₂, where the first pitch P₁ is less than the second pitch P₂ of the second cylindrical lens.

In this embodiment, the total preset cylindrical lens number m of the stereoscopic display substrate is known, the following Formula (13), Formula (14) and Formula (15) are obtained by substituting m into Formula (2), Formula (6) and Formula (8), and the first pitch P₁ is calculated based on Formula (1) and the above formulas.

Specifically, the first pitch P₁ of the first cylindrical lens satisfies:

$${y}_{k} ( m ) = {\sum }_{i = 0}^{k} {P}_{1} ( k = m ) + hn tan {θ}_{2} \qquad Formula ( 13 )$$

$${y}_{0} ( m ) = m \times Δ x \qquad Formula ( 14 )$$

$${y}_{k} ( m ) - {y}_{0} ( m ) \leq M \qquad Formula ( 15 )$$

$$Δ x = {P}_{1} \times \frac{{E}_{𝓏} + h}{{E}_{𝓏}} \qquad Formula ( 16 )$$

After the first pitch P₁ is calculated, the number of cylindrical lenses from the field of view origin to an edge of the first region is kₘₐₓ and the second pitch P₂ of the second cylindrical lens in the second region are respectively calculated based on the following Formula (17):

$$\{ \begin{matrix}{y}_{k = {k}_{max}} - {k}_{max} Δ x = - M \\ {y}_{k = {k}_{max}} - {k}_{max} Δ x = M \\ Δ x = {P}_{2} \times \frac{{E}_{z} + h}{{E}_{z}}\end{matrix} \qquad Formula ( 17 )$$

As shown in FIG. 5A, the first region is A1 and the second region is A2. After the first pitch P₁ is determined in the above steps, kₘₐₓ and the second pitch P₂ are calculated based on the above Formula 17.

As shown in FIG. 5A, the number of cylindrical lenses from the field of view origin O to a side of the cylindrical lens grating unit is m. The pitches of the cylindrical lenses of the cylindrical lens grating unit in the first region are constantly P₁, and the pitches of the cylindrical lenses of the cylindrical lens grating unit in the second region on a side of the first region away from the field of view origin O are constantly P₂.

As shown in FIG. 5A, the pitches P₁ of the cylindrical lenses in the first region satisfies: P₁=P₃₁=P₃₂<P₂=P₃₃. That is, the pitches P₁ of the cylindrical lenses in the first region are equal, and the pitches P₂ of the cylindrical lenses in the second region are equal, where P₁<P₂.

According to the above Formula 17, for example, when the spacing E_{z} between the human eye and the display substrate is 700 mm, a position of the human eyes corresponds to a central position of the screen, that is, the position of the human eyes directly faces the field of view origin O, and the number m of cylindrical lenses in a range from the field of view origin O to a cylindrical lens farthest away from the human eyes is 4800, it is calculated based on the above formula that kₘₐₓ is 3795, P₁ is 0.1451432 mm, and P₂ is 0.1451538 mm. After optimization, the crosstalk reduction effect is as shown in FIG. 5B, where the crosstalk rate is less than 1 within the range of the 4800 cylindrical lenses. Therefore, the crosstalk may meet the requirements. A crosstalk rate in a case of applying a segmented design to the pitch of the cylindrical lens in the cylindrical lens grating element is rate(k), and a crosstalk rate a case of not applying the segmented design to the pitch of the cylindrical lens in the cylindrical lens grating element is rate(kₙₒₙ). According to FIG. 5B, the crosstalk of the display substrate may be effectively reduced and the display effect may be improved in the case of applying the segmented design to the pitch of the cylindrical lens in the cylindrical lens grating element.

In some implementable embodiments of the present disclosure, a protrusion of the cylindrical lens of the cylindrical lens grating unit in the display substrate may be designed to protrude towards the base substrate or away from the base substrate, and the pitch of the cylindrical lens may adopt the above-mentioned solutions of the linear variation design, the nonlinear variation design and the segmented variation design.

In some embodiments of the present disclosure, a material for manufacturing the cylindrical lens includes a hard material such as organic glass, polycarbonate, epoxy acrylate, polyurethane acrylate, unsaturated polyester, etc., or a soft PET material.

For example, in some embodiments of the present disclosure, the cylindrical lens grating unit includes a hard substrate and a plurality of cylindrical lenses. By selecting the hard material as the material for forming the cylindrical lens, the problem of crosstalk caused by the process of attaching the cylindrical lens grating unit to other film layers (e.g., a display unit) may be effectively avoided, so as to reduce the crosstalk of the entire display substrate.

For example, in some other embodiments of the present disclosure, the cylindrical lens in the cylindrical lens grating unit may be made of the soft PET material. By providing a hard substrate on the cylindrical lens grating unit, the problem of crosstalk caused by the process of attaching the cylindrical lens grating unit to other film layers may be effectively avoided, so as to reduce the crosstalk of the entire display substrate and effectively improve the display effect of the stereoscopic display substrate.

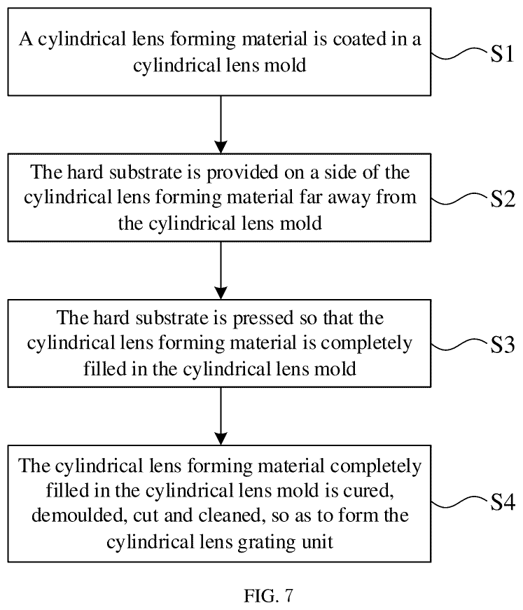

FIG. 7 schematically shows a flowchart of manufacturing a cylindrical lens grating unit.

In some embodiments of the present disclosure, the cylindrical lens grating unit is manufactured using a method including operations S1 to S4.

In operation S1, a cylindrical lens forming material is coated in a cylindrical lens mold.

For example, the cylindrical lens mold may be a sheet mold or a roller mold.

In operation S2, the hard substrate is provided on a side of the cylindrical lens forming material away from the cylindrical lens mold.

In operation S3, the hard substrate is pressed so that the cylindrical lens forming material is completely filled in the cylindrical lens mold.

In operation S4, the cylindrical lens forming material completely filled in the cylindrical lens mold is cured, demoulded, cut and cleaned, so as to form the cylindrical lens grating unit.

In an implementable embodiment, the cylindrical lens grating unit may adopt a Plate to Plate UV transfer printing process, which specifically includes: step 1, placing and fixing a sheet mold on a base substrate; step 2, coating a UV glue on a side of the sheet mold with microstructure parameters; step 3, fixing a glass substrate on the sheet mold; step 4, rolling on the glass substrate with a pressing roller, so as to uniformly fill the UV glue in the mold and imprint it on the base substrate; step 5, performing UV curing by using ultraviolet irradiation; step 6, demoulding the cylindrical lenses; step 7, cutting and cleaning; and step 8, obtaining finished products, and performing appearance inspection and optical inspection.

In another implementable embodiment, the cylindrical lens grating unit may adopt a Roll to Plate UV transfer printing process, which specifically includes: step 1, placing and fixing a glass substrate on a vacuum adsorption platform, and making preparations such as cleaning, etc.; step 2, coating a UV glue on a side of a microstructure optical roller mold; step 3, imprinting a cylindrical lens structure on a material by using an optical roller mold designed with microstructure parameters; step 4, performing UV curing by using ultraviolet irradiation; step 5, performing appearance inspection and optical inspection; and step 6, cutting at a specified cylindrical lens angle, and packaging.

In yet another implementable embodiment, the cylindrical lens grating unit may adopt a Roll to Roll process, which specifically includes: step 1, unwinding and feeding a material; step 2, coating a UV glue on the material by using a coating head; step 3, imprinting a cylindrical lens structure on a material by using an optical roller designed with microstructure parameters; step 4, performing UV curing by using ultraviolet irradiation; step 5, performing appearance inspection and optical inspection; and step 6, winding, and cutting at a specified cylindrical lens angle. Further, the hard substrate is provided on a side of the cylindrical lenses away from the protrusions, so as to form the cylindrical lens grating unit.

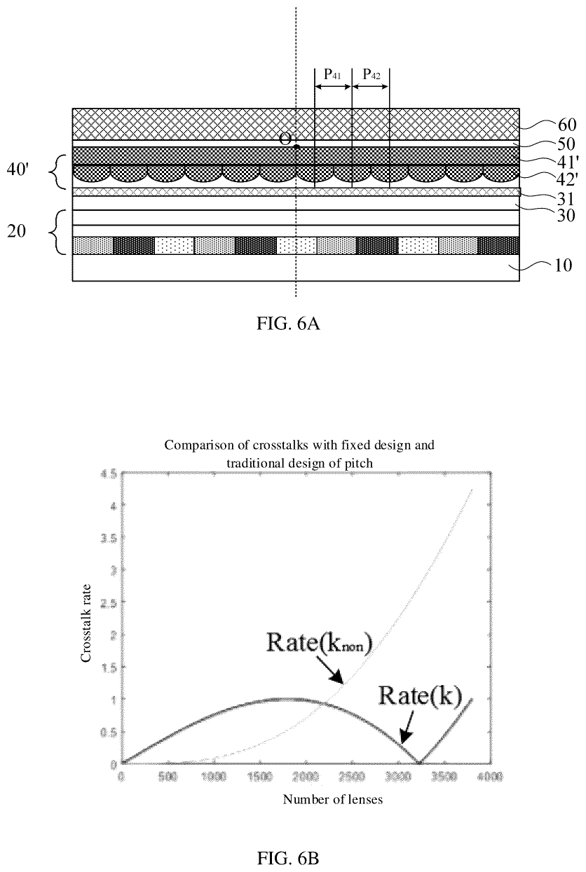

FIG. 6A schematically shows a cross-sectional structural schematic diagram of a stereoscopic display substrate according to yet another exemplary embodiment of the present disclosure. FIG. 6B schematically shows a diagram of a variation relationship between a crosstalk rate and a number of cylindrical lenses of the stereoscopic display substrate in FIG. 6A.

As shown in FIG. 6A, in this embodiment, the stereoscopic display substrate includes a base substrate 10, a display unit 20, a first medium layer 30, a cylindrical lens grating unit 40′, a second medium layer 50 and an encapsulation layer 60.

The cylindrical lens grating unit 40′ includes a hard substrate 41′ and a plurality of cylindrical lenses 42′. The hard substrate 41′ is disposed on a side away from the base substrate 10. The cylindrical lens 42′ is disposed on a side close to the base substrate 10. The cylindrical lens has a convex curved surface, and the convex curved surface faces the side close to the base substrate. A glass substrate 31 is further arranged between the first medium layer 30 and the cylindrical lens grating unit 40′. The glass substrate 31 is used to flatten a region between the cylindrical lens grating unit 40′ and the display unit 20, so as to prevent the crosstalk caused by process fluctuations in the attachment process.

In this embodiments, in the first direction, the pitches P of the respective cylindrical lenses in the cylindrical lens grating unit are equal. As shown in FIG. 6A, P₄₁ a region=P₄₂. In the this embodiment, in order to avoid problems of complicated process, increased production cost, etc. due to inconsistent pitches of the cylindrical lens when applying the linear design or the nonlinear design, the pitch of the cylindrical lens is designed as a set value in this embodiments, so that the stereoscopic display substrate which may reduce or avoid the crosstalk may be manufactured a lower cost.

For example, the pitch P of each cylindrical lens is calculated based on the preset cylindrical lens number m of the plurality of cylindrical lenses, the refractive pixel spacing yₖ, the original pixel spacing yₒ and the crosstalk limit M. The refractive pixel spacing yₖ is a spacing between a pixel unit corresponding to a k^{th} cylindrical lens and the field of view origin in the case of taking the cylindrical lens refraction into account, where k is an integer greater than 0. A difference between the refractive pixel spacing yₖ and the original pixel spacing yₒ of the cylindrical lens is less than or equal to the crosstalk limit M, and the crosstalk limit is associated with a pitch of the pixel unit in the first direction, and the original pixel spacing yₒ is a spacing between the pixel unit corresponding to the k^{th} cylindrical lens and the field of view origin in the case of not taking the cylindrical lens into account.

For example, when the preset number of cylindrical lenses is known, Formula (13), Formula (14) and Formula (15) are respectively obtained by substituting m into the above-mentioned Formula (2), Formula (6) and Formula (8). Then, the pitch P of the cylindrical lens is calculated based on Formula (1) and the above-mentioned formulas.

In the case that the spacing E_{z} between the human eye position and the display substrate is 700 mm, the human eyes are located at the preset field of view position (0,0,700), the preset cylindrical lens number m of the cylindrical lenses in a range from the field of view origin to a cylindrical lens farthest from the human eyes in the first direction is 3800, P is calculated based on the above Formulas (1) to (8) to be equal to 0.145143 mm, according to the original design of P=0.1451 mm.

As shown in FIG. 6B, within a range of the preset lens number m being equal to 3800, the crosstalk rate (rate(k)) in the case of applying the design of the pitch of the cylindrical lens in the cylindrical lens grating unit is less than 1, and the crosstalk rate (rate(kₙₒₙ)) in the case of not applying the design of the pitch of the cylindrical lens in the cylindrical lens grating unit is more than 1 after exceeding about 2300. Therefore, by setting the pitch of the cylindrical lens at a fixed value, compared with original pitches of the cylindrical lenses, the problem of crosstalk of the cylindrical lens may be effectively improved.

In another aspect of the present disclosure, a display apparatus is further provided. The display apparatus includes the above-mentioned display substrate.

The beneficial effects achieved by the display apparatus in the above-mentioned embodiments of the present disclosure are the same as the beneficial effects achieved by the above-mentioned display substrate, which will not be repeated here.

The above-mentioned display apparatus may be any apparatus that displays motion images (e.g., video) or fixed images (e.g., still images) and words or images. More specifically, it is expected that the embodiments may be implemented in or associated with various electronic apparatuses, including but not limited to, a mobile phone, a wireless apparatus, a personal data assistant (PDA), a handheld or portable computer, a GPS receiver/navigator, a camera, an MP4 video player, a video camera, a game console, a watch, a clock, a calculator, a television monitor, a flat panel display, a computer monitor, an automobile display (e.g., Odometer display, etc.), a navigator, a cabin controller and/or a display, a display of camera views (e.g., a display of a rear-view camera in a vehicle), an electronic photograph, an electronic billboard or sign, a projector, a building structure, a packaging and aesthetic structure (e.g., a display of images of a piece of jewelry), etc.

Although some embodiments of the general inventive concept of the present disclosure have been illustrated and described, those skilled in the art will understand that changes may be made to these embodiments, without departing from the principle and spirit of the general inventive concept of the present disclosure, and the scope of the present disclosure is determined by the claims and their equivalents.

1. A stereoscopic display substrate, comprising:
a base substrate;
a display unit disposed on a side of the base substrate, wherein the display unit comprises a plurality of pixel units arranged in an array in a first direction and a second direction, the plurality of pixel units have a periodic pixel width Δx in the first direction, and the first direction intersects with the second direction;
a first medium layer disposed on a side of the display unit away from the base substrate; and
a cylindrical lens grating unit disposed on a side of the first medium layer away from the base substrate, wherein the cylindrical lens grating unit comprises a hard substrate and a plurality of cylindrical lenses contiguously arranged in the first direction, and each of the plurality of cylindrical lenses has a pitch P,
wherein the stereoscopic display substrate has a preset field of view position with an optimal display effect in a third direction, and the third direction is perpendicular to both the first direction and the second direction;
wherein in a direction away from a field of view origin along the first direction, pitches P of the cylindrical lenses increase, the field of view origin is an intersection of the third direction, the first direction and the second direction, and a spacing between the preset field of view position and the field of view origin in the third direction is E_{z};
wherein the pitch P of each of the plurality of cylindrical lenses is calculated based on a refractive pixel spacing yₖ and at least one of a preset cylindrical lens number m of the plurality of cylindrical lenses and the periodic pixel width Δx, and the refractive pixel spacing yₖ is a spacing between a pixel unit corresponding to a k^{th} cylindrical lens and the field of view origin in a case of taking cylindrical lens refraction into account, k being an integer greater than 0; and
wherein a difference between the refractive pixel spacing yₖ and an original pixel spacing yₒ of the cylindrical lens is less than or equal to a crosstalk limit M, the crosstalk limit is associated with a pitch of the pixel unit in the first direction, and the original pixel spacing yₒ is a spacing between the pixel unit corresponding to the k^{th} cylindrical lens and the field of view origin in a case of not taking the cylindrical lens refraction into account.

2. The stereoscopic display substrate according to claim 1, wherein
the pitch P, the refractive pixel spacing yₖ and the original pixel spacing yₒ satisfy:
$${y}_{k} ( k ) = {\sum }_{i = 0}^{k} P ( k ) + hn tan {θ}_{2} , \qquad ( 1 )$$
$${y}_{0} ( k ) = k \times Δ x , \qquad ( 2 )$$
$${y}_{k} ( k ) - {y}_{0} ( k ) \leq M , \qquad ( 3 )$$
wherein h is an equivalent air spacing between the cylindrical lens and the display unit, n is a ratio of a refractive index n₂ of the cylindrical lens to a refractive index n₁ of the first medium layer, and 0, is an included angle between light and a normal in the cylindrical lens.

3. The stereoscopic display substrate according to claim 2, wherein
in the direction away from the field of view origin along the first direction, the pitches P of the cylindrical lenses increase linearly; and
wherein the pitch P of the k^{th} cylindrical lens is calculated based on the periodic pixel width Δx, the refractive pixel spacing yₖ of the k^{th} cylindrical lens and a pitch Pₒ of a cylindrical lens at the field of view origin.

4. The stereoscopic display substrate according to claim 3, wherein
the pitch P of the k^{th} cylindrical lens satisfies following linear relationships:
$$P = α \times \frac{{P}_{max} - {P}_{min}}{{k}_{max} - {k}_{min}} \times k , \qquad ( 4 )$$
$${y}_{k} - {y}_{k - 1} = Δ x , \qquad ( 5 )$$
$$Δ x = {P}_{0} \times \frac{{E}_{𝓏} + h}{{E}_{𝓏}} , \qquad ( 6 )$$
wherein α is a correction coefficient, Pₘᵢₙ=P₀, and Pₘₐₓ is calculated based on the refractive pixel spacing yₖ of the k^{th} cylindrical lens and the pitch P₀ of the cylindrical lens at the field of view origin.

5. The stereoscopic display substrate according to claim 4, wherein
a range of α is 2.2≤α≤2.6.

6. The stereoscopic display substrate according to claim 2,
wherein in the direction away from the field of view origin along the first direction, the pitches P of the cylindrical lenses increase nonlinearly; and
wherein the pitch P of the k^{th} cylindrical lens is calculated based on the periodic pixel width Δx, the refractive pixel spacing yₖ of the k^{th} cylindrical lens and a pitch P₀ of a cylindrical lens at the field of view origin.

7. The stereoscopic display substrate according to claim 6, wherein
the pitch P of the k^{th} cylindrical lens satisfies:
$${y}_{k} = {\sum }_{i = 0}^{k} P ( k ) + ( \frac{h}{\sqrt{1 - \frac{1}{{n}^{2}} + {( \frac{{E}_{𝓏}}{{\sum }_{i = 0}^{k} P ( k )} )}^{2}}} ) ) , \qquad ( 7 )$$
$${y}_{k} - {y}_{k - 1} = Δ x , \qquad ( 8 )$$
$$Δ x = {P}_{0} \times \frac{{E}_{𝓏} + h}{{E}_{𝓏}} , \qquad ( 9 )$$
wherein k>0.

8. The stereoscopic display substrate according to claim 7, wherein
an absolute value of the difference between the refractive pixel spacing yₖ of the k^{th} cylindrical lens and the original pixel spacing y₀ of the k^{th} cylindrical lens approaches 0.

9. The stereoscopic display substrate according to claim 2,
wherein in the direction away from the field of view origin along the first direction, the pitches P of the cylindrical lenses increase in stages; and
wherein the pitch P of the k^{th} cylindrical lens is calculated based on the preset cylindrical lens number m, the refractive pixel spacing yₖ, the original pixel spacing yₒ and the crosstalk limit M.

10. The stereoscopic display substrate according to claim 9, wherein in the first direction, the cylindrical lens comprises a first cylindrical lens in a first region and a second cylindrical lens in a second region, the first cylindrical lens in the first region has a first pitch P₁, and the second cylindrical lens in the second region has a second pitch P₂,
wherein the first pitch P₁ is less than the second pitch P₂.

11. The stereoscopic display substrate according to claim 10, wherein
the first pitch P₁ of the first cylindrical lens satisfies:
$${y}_{k} ( m ) = {\sum }_{i = 0}^{k} {P}_{1} ( k = m ) + hn tan {θ}_{2} , \qquad ( 10 )$$
$${y}_{0} ( m ) = m \times Δ x , \qquad ( 11 )$$
$${y}_{k} ( m ) - {y}_{0} ( m ) \leq M , \qquad ( 12 )$$
$$Δ x = {P}_{1} \times \frac{{E}_{𝓏} + h}{{E}_{𝓏}} , \qquad ( 13 )$$
wherein m is the preset number of cylindrical lenses which is known.

12. The stereoscopic display substrate according to claim 11, wherein
in the first direction, a number of cylindrical lenses from the field of view origin to an edge of the first region is kₘₐₓ, and the second pitch P₂ of the second cylindrical lens in the second region satisfies:
$$\{ \begin{matrix}{y}_{k = {k}_{max}} - {k}_{max} Δ x = - M \\ {y}_{k = {k}_{max}} - {k}_{max} Δ x = M \\ Δ x = {P}_{2} \times \frac{{E}_{𝓏} + h}{{E}_{𝓏}}\end{matrix} , \qquad ( 14 )$$
wherein P₂ is calculated based on Formula (14) and Formula (1).

13. The stereoscopic display substrate according to claim 1, wherein the hard substrate is disposed on a side close to the base substrate; and
wherein the cylindrical lens has a convex curved surface facing a side away from the base substrate.

14. The stereoscopic display substrate according to claim 1, wherein the hard substrate is disposed on a side away from the base substrate; and
wherein the cylindrical lens has a convex curved surface facing a side close to the base substrate.

15. The stereoscopic display substrate according to claim 1, further comprising:
a second medium layer disposed on a side of the cylindrical lens grating unit away from the base substrate; and
an encapsulation layer disposed on a side of the second medium layer away from the base substrate.

16. The stereoscopic display substrate according to claim 1, wherein
the cylindrical lens is made of a material comprising organic glass, a hard polycarbonate material, or a soft PET material.

17. The stereoscopic display substrate according to claim 1, wherein the cylindrical lens grating unit is manufactured by:
coating a cylindrical lens forming material in a cylindrical lens mold;
providing the hard substrate on a side of the cylindrical lens forming material away from the cylindrical lens mold;
pressing the hard substrate so that the cylindrical lens forming material is completely filled in the cylindrical lens mold; and
curing, demoulding, cutting and cleaning the cylindrical lens forming material completely filled in the cylindrical lens mold, so as to form the cylindrical lens grating unit.

18. A stereoscopic display substrate, comprising:
a base substrate;
a display unit disposed on a side of the base substrate, wherein the display unit comprises a plurality of pixel units arranged in an array in a first direction and a second direction, the plurality of pixel units have a periodic pixel width Δx in the first direction, and the first direction intersects with the second direction;
a first medium layer disposed on a side of the display unit away from the base substrate; and
a cylindrical lens grating unit disposed on a side of the first medium layer away from the base substrate, wherein the cylindrical lens grating unit comprises a hard substrate and a plurality of cylindrical lenses contiguously arranged in the first direction, and each of the plurality of cylindrical lenses has a pitch P,
wherein the stereoscopic display substrate has a preset field of view position with an optimal display effect in a third direction, and the third direction is perpendicular to the first direction and the second direction;
wherein in a direction away from a field of view origin along the first direction, pitches P of the cylindrical lenses are equal, and a spacing between the preset field of view position and the field of view origin in the third direction is E_{z};
wherein the pitch P of each of the plurality of cylindrical lenses is calculated based on a preset cylindrical lens number m of the plurality of cylindrical lenses, a refractive pixel spacing yₖ, an original pixel spacing yₒ and a crosstalk limit M, and the refractive pixel spacing yₖ is a spacing between a pixel unit corresponding to a k^{th} cylindrical lens and the field of view origin in a case of taking cylindrical lens refraction into account, k being an integer greater than 0; and
wherein a difference between the refractive pixel spacing yₖ and the original pixel spacing yₒ of the cylindrical lens is less than or equal to the crosstalk limit M, the crosstalk limit is associated with a pitch of the pixel unit in the first direction, and the original pixel spacing yₒ is a spacing between the pixel unit corresponding to the k^{th} cylindrical lens and the field of view origin in a case of not taking the cylindrical lens refraction into account.

19. A display apparatus, comprising the display substrate according to claim 1.

20. A display apparatus, comprising the display substrate according to claim 18.
